(19) United States
(12) Patent Application Publication
(10) Pub. No.: US 2020/0092385 A1
(43) Pub. Date: Mar. 19, 2020

(54) INFORMATION PROVISION CONTROL SYSTEM AND INFORMATION PROVISION CONTROL METHOD

(71) Applicant: FUJITSU LIMITED, Kawasaki-shi (JP)

(72) Inventors: Takao Ogura, Yokohama (JP); Yuji Yamaoka, Kawasaki (JP)

(73) Assignee: FUJITSU LIMITED, Kawasaki-shi (JP)

(21) Appl. No.: 16/570,445

(22) Filed: Sep. 13, 2019

(30) Foreign Application Priority Data
Sep. 19, 2018 (JP) 2018-175086

(51) Int. Cl. H04L 29/08; H04L 29/06

(52) U.S. Cl. CPC H04L 67/22; H04L 67/42

(57) ABSTRACT

An information provision control system includes an intermediary device including a memory, and a processor configured to receive, from a first terminal device, extraction information related to an acquisition request transmitted by the first terminal device to a second terminal device storing user data, determine, based on the received extraction information, a plurality of users which are targets for the acquisition request, and transmit first information indicating the determined plurality of users to the second terminal device.

### CROSS-REFERENCE TO RELATED APPLICATION

This application is based upon and claims the benefit of priority of the prior Japanese Patent Application No. 2018-175086, filed on Sep. 19, 2018, the entire contents of which are incorporated herein by reference.

### FIELD

The embodiment relates to an information provision control technique.

### BACKGROUND

As a service of managing personal data owned by each of various service providers, a personal data store (PDS) exists. Such personal data is also referred to as user data. The development of methods for providing personal data to third parties has been widely carried out in order for the third parties to use the personal data.

As a method for providing personal data to a third party, User-Managed Access (UMA) exists. In UMA, an authorization server (AS) is installed between a client server of a client (data user) that is a third party and a resource server (RS) of a service provider (data provider). The authorization server serves as an intermediary device and mediates data coordination between the client server and the resource server.

In a system using UMA, an authorization server acquires a client's consent by proxy, and a resource server directly provides personal data to a client server without using a PDS.

For example, a related technique has been disclosed in Japanese Laid-open Patent Publication No. 2015-201098.

### SUMMARY

According to an aspect of the embodiments, an information provision control system includes an intermediary device including a memory, and a processor configured to receive, from a first terminal device, extraction information related to an acquisition request transmitted by the first terminal device to a second terminal device storing user data, determine, based on the received extraction information, a plurality of users which are targets for the acquisition request, and transmit first information indicating the determined plurality of users to the second terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying a hardware configuration of an information processing system as an example of an embodiment;

FIG. 2 is a diagram exemplifying a hardware configuration of an information processing device included in the information processing system as the example of the embodiment;

FIG. 3 is a diagram exemplifying a hardware configuration of a user terminal included in the information processing system as the example of the embodiment;

FIG. 4 is a diagram exemplifying a functional configuration of the information processing device included in the information processing system as the example of the embodiment;

FIG. 5 is a diagram exemplifying token information held in the information processing system as the example of the embodiment;

FIG. 6 is a diagram exemplifying an overview of a control process to be executed in the information processing system as the example of the embodiment;

FIG. 7 is a diagram exemplifying the overview of the control process to be executed in the information processing system as the example of the embodiment;

FIG. 8 is a diagram exemplifying consent information held in the information processing system as the example of the embodiment;

FIG. 9 is a diagram exemplifying user policy information held in the information processing system as the example of the embodiment;

FIG. 10 is a diagram exemplifying a control process of a phase 1 in the information processing system as the example of the embodiment;

FIG. 11 is a diagram exemplifying filter information managed by a resource server included in the information processing system as the example of the embodiment;

FIG. 12 is a diagram exemplifying a response message to be used in the information processing system as the example of the embodiment;

FIG. 13 is a diagram exemplifying filter information managed by a client server included in the information processing system as the example of the embodiment;

FIG. 14 is a diagram exemplifying a control process of a phase 2 in the information processing system as the example of the embodiment;

FIG. 15 is a diagram exemplifying user information held in the information processing system as the example of the embodiment;

FIGS. 16A and 16B are a flowchart exemplifying the control process of the phase 1 in the information processing system as the example of the embodiment;

FIGS. 17A and 17B is a flowchart exemplifying the control process of the phase 2 in the information processing system as the example of the embodiment;

FIG. 18 is a diagram exemplifying a control process of a phase 1 in an information processing system as a modified example; and

FIG. 19 is a diagram exemplifying a control process of a phase 2 in the information processing system as the modified example.

### DESCRIPTION OF EMBODIMENTS

UMA is a protocol for coordinating personal data for each of users (owners) to which the personal data belong. Thus, in a system using UMA, a client server acquires the personal data from a resource server for each of the users. Thus, in the related technique, when the client server tries to acquire personal data on many users, a large quantity of messages are transmitted.

Hereinafter, an embodiment of the present disclosure is described. However, the embodiment described below is an example and is not intended to exclude the application of various variations or techniques which are not explicitly described below. For example, various modifications to the embodiment may be made within a scope that does not depart from the gist of the embodiment. Elements or components assigned the same reference numeral in the drawings used for the following embodiment will represent identical or similar elements or components unless otherwise specified.

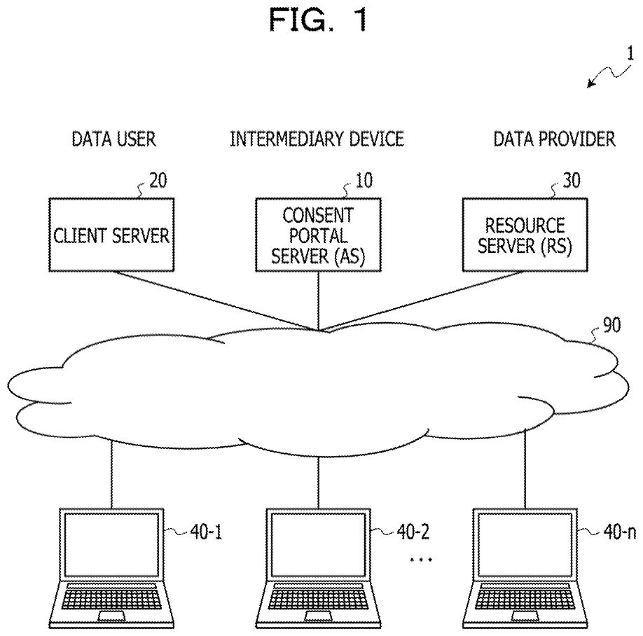

FIG. 1 is a diagram exemplifying a hardware configuration of an information processing system 1 as an example of the embodiment. In the information processing system 1 as the example of the embodiment, a consent portal server 10 is installed as an authorization server. The information processing system is an example of an information provision control system.

As Illustrated in FIG. 1, the information processing system 1 includes the consent portal server 10, a client server 20, a resource server 30, and one or more user terminals 40-1, 40-2, . . . , and 40-n (n is an integer) that are used by one or more users. As a reference indicating any of the user terminals, the reference 40-1, 40-2, . . . , or 40-n is used to identify one of the multiple user terminals. The reference “40” is used to indicate arbitrary one or more of the multiple user terminals. The consent portal server 10, the client server 20, the resource server 30, and the multiple user terminals 40 are coupled to each other via a network 90 such as the Internet.

The client server 20 is used by a client that is a data user. The resource server 30 is used by a data provider. The consent portal server 10 corresponds to an authorization server (AS). The resource server 30 is also referred to as RS. The consent portal server 10 is also referred to as information processing device or intermediary device.

FIG. 1 illustrates an example in which the information processing system 1 includes the single consent portal server 10, the single client server 20, and the single resource server 30. The information processing system 1, however, may include multiple consent portal servers 10, multiple client servers 20, and multiple resource servers 30.

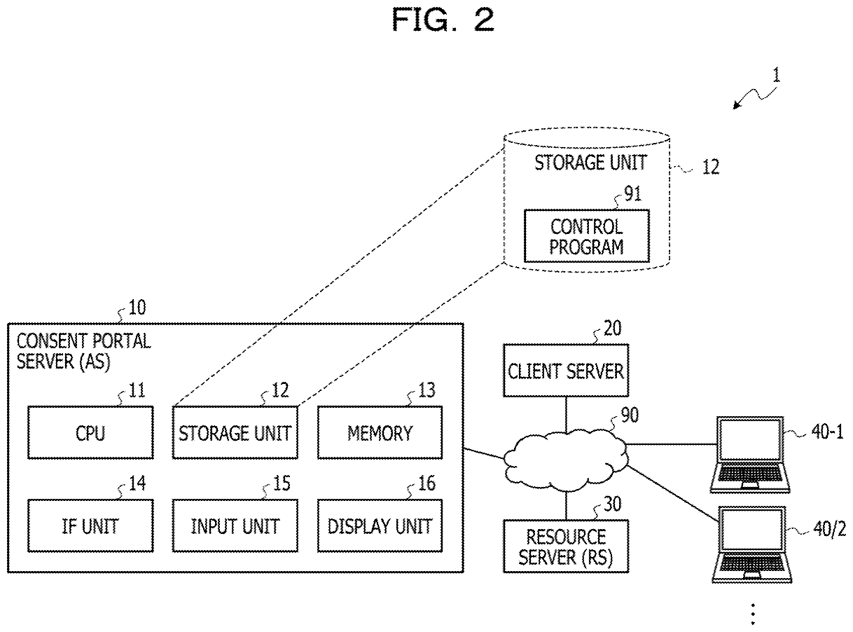

FIG. 2 is a diagram exemplifying a hardware configuration of the consent portal server 10 included in the information processing system 1 as the example of the embodiment.

The consent portal server 10 is a computer having a server function. As illustrated in FIG. 2, the consent portal server 10 may include a central processing unit (CPU) 11, a storage unit 12, a memory 13, an interface (IF) unit 14, an input unit 15, and a display unit 16.

The CPU 11 executes an operating system (OS) stored in the storage unit 12 (described later) and a program stored in the storage unit 12 to control the consent portal server 10 in order to enable communication in the information processing system 1, for example. In the embodiment, the CPU 11 executes a control program 91 described later.

The storage unit 12 is an example of hardware for storing various data, programs, and the like. For example, the storage unit 12 may be used as a secondary storage device of the consent portal server 10 and may store various data and programs including the OS, firmware, and an application. Examples of the storage unit 12 are a magnetic disk device such as a hard disk drive (HDD) and semiconductor storage devices such as a solid state drive (SD) and a storage class memory (SCM). The storage unit 12 may store a program including a plurality of instructions that enables some or all of various functions of the consent portal server 10.

The memory 13 is an example of hardware for storing various data, a program, and the like. The memory 13 is a volatile memory or the like. An example of the memory 13 is a RAM such as a dynamic RAM (DRAM). RAM is an abbreviation for random access memory.

The IF unit 14 is an example of a communication interface that controls coupling and communication between the client server 20, the resource server 30, and the multiple user terminals 40 via the network 90. An example of the IF unit 14 is an adaptor conforming to Ethernet (registered trademark), optical communication (for example, Fibre Channel), or the like. The consent portal server 10 may include a communication interface that controls coupling and communication between the consent portal server 10 and a managing terminal (not illustrated) of an administrator. The consent portal server 10 may use the communication interface to download the control program 91 via the network 90.

The input unit 15 may include one or more of input devices that are a mouse, a keyboard, a touch panel, an operational button, and the like, for example.

The display unit 16 may include one or more of output devices that are a display, a projector, a speaker, a printer, and the like, for example.

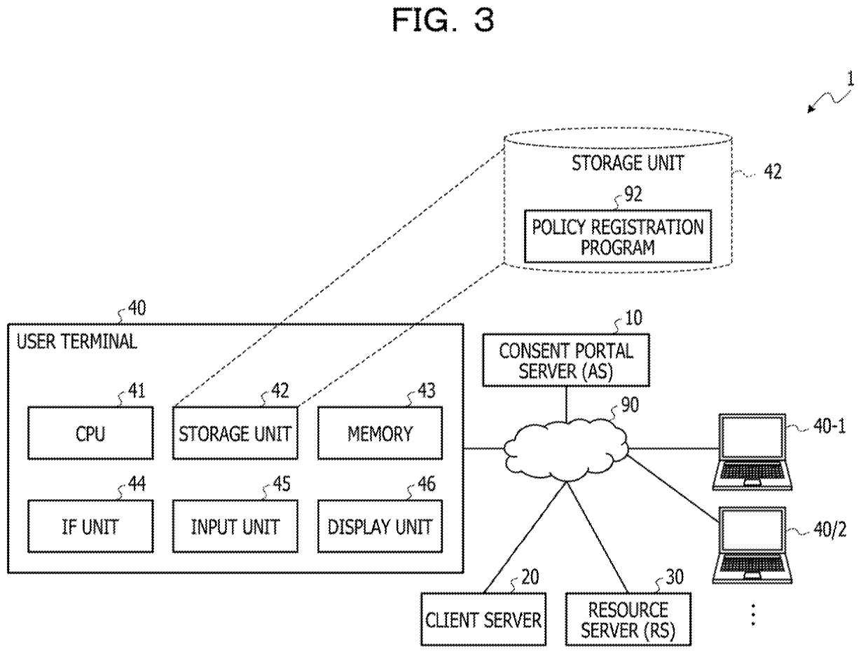

FIG. 3 is a diagram exemplifying a hardware configuration of a user terminal 40 included in the information processing system 1 as the example of the embodiment.

As illustrated in FIG. 3, the user terminal 40 may include a CPU 41, a storage unit 42, a memory 43, an IF unit 44, an input unit 45, and a display unit 46.

The user terminal 40 is coupled to the consent portal server 10, the client server 20, the resource server 30, and the other user terminals 40 via the network 90 such as the Internet.

The CPU 41 executes an OS stored in the storage unit 42 (described later) and a program stored in the storage unit 42 to enable communication within the information processing system 1. In the embodiment, the CPU 41 executes a policy registration program 92 described later.

The storage unit 42 is an example of hardware for storing various data, programs, and the like. For example, the storage unit 42 may be used as a secondary storage device of the user terminal 40 and may store various data and programs including the OS, firmware, and an application. Examples of the storage unit 42 are a magnetic disk drive such as an HDD and semiconductor storage devices such as an SD and an SCM. The storage unit 42 may store a program including a plurality of instructions that enables some or all of various functions of the user terminal 40.

The memory 43 is an example of hardware for storing various data, a program, and the like. The memory 43 is a volatile memory or the like. An example of the memory 43 is a RAM such as a DRAM.

The IF unit 44 is an example of a communication interface that controls coupling and communication between the consent portal server 10, the client server 20, the resource server 30, and the other user terminals 40 via the network 90. An example of the IF unit 44 is an adaptor conforming to Ethernet (registered trademark), optical communication (for example, Fibre Channel), or the like. The user terminal 40 may include a communication interface that controls coupling and communication between the user terminal 40 and the managing terminal (not illustrated) of the administrator. The user terminal 40 may use the communication interface to download the policy registration program 92 via the network 90.

The input unit 45 may include one or more of input devices that are a mouse, a keyboard, a touch panel, an operational button, and the like, for example.

The display unit 46 may include one or more of output devices that are a display, a projector, a speaker, a printer, and the like, for example.

Examples of the user terminal 40 configured as described above are computers that are a personal computer (PC), a tablet, a smartphone, a personal digital assistant (PDA), a mobile phone, and the like.

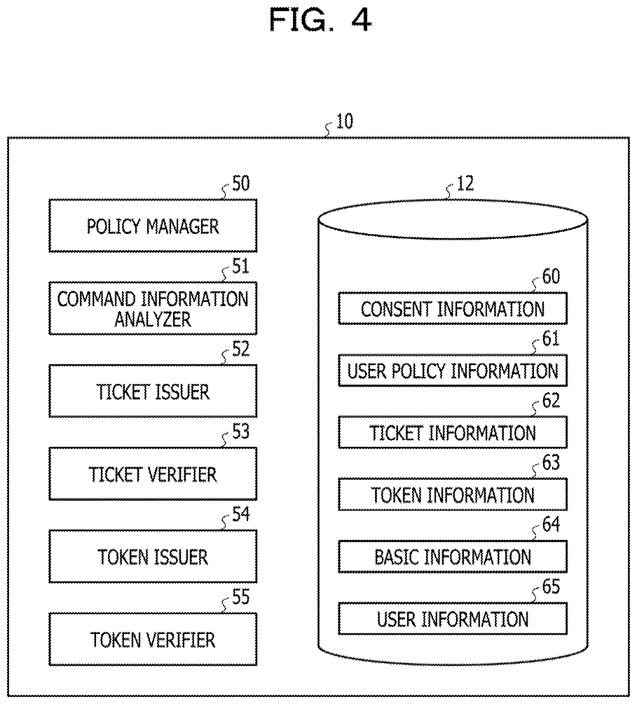

FIG. 4 is a diagram exemplifying a functional configuration of the consent portal server 10 included in the information processing system 1 illustrated in FIG. 2 as the example of the embodiment.

As illustrated in FIG. 4, the consent portal server 10 may include a policy manager 50, a command information analyzer 51, a ticket issuer 52, a ticket verifier 53, a token issuer 54, and a token verifier 55 as an example.

As Illustrated in FIG. 4, the storage unit 12 may store consent information 60, user policy information 61, ticket information 62, token information 63, basic information 64, and user information 65.

The policy manager 50 acquires, from a user, information indicating whether the user agrees on a contract between the user and the client (data user) regarding handling of personal data of the user. The policy manager 50 causes the acquired information to be stored in, for example, the consent information 60 stored in the storage unit 12. In the embodiment, the policy manager 50 acquires, from the user, information indicating whether the user agrees that the personal data of the user is disclosed to the client, and the policy manager 50 causes the acquired information to be stored in the consent information 60 stored in the storage unit 12. The consent information 60 is described later.

The policy manager 50 acquires an access control policy (described later) registered by the user using the user terminal 40 and causes the acquired access control policy to be stored in the user policy information 61 stored in the storage unit 12. In the embodiment, the policy manager 50 acquires, from the user, information that is included in the personal data of the user and that the user does not want to disclose to the client (data user), and the policy manager 50 causes the acquired information to be stored in the user policy information 61 stored in the storage unit 12. The user policy information 61 is described later. The policy manager is an example of a target user extractor.

The command information analyzer 51 holds and analyzes command information acquired from the resource server 30. In the embodiment, when a command acquired by the command information analyzer 51 is “meta_info” as a result of the analysis of the acquired command information, the command information analyzer 51 determines that a current process is in a phase 1 (described later in detail).

On the other hand, when the acquired command is “M_all”, the command information analyzer 51 determines that the current process is in a phase 2 (described later in detail).

Ticket issuer 52 generates a ticket and transmits (issues) the generated ticket to the resource server 30. The ticket is known for a secure data coordination technique and will not be described in detail. In the embodiment, the ticket is used to issue a token (described later) to the client server 20.

The ticket issuer 52 may use a known ticket generation method for UMA to generate the ticket.

The ticket issuer 52 causes information on the transmitted ticket to be stored in the ticket information 62 stored in the storage unit 12. In this case, the ticket issuer 52 may associate the information on the transmitted ticket with an identifier (ID) of a session between the consent portal server 10 and the resource server 30 and information of the client server 20 and cause the information on the transmitted ticket to be stored in the ticket information 62. The ticket information 62 is described later.

The ticket verifier 53 receives a ticket transmitted by the client server 20 and verifies whether the received ticket is the same as the ticket generated by the ticket issuer 52. In this case, the ticket verifier 53 may reference the ticket information 62 and execute the verification.

The token issuer 54 generates a token and transmits (issues) the generated token to the client server 20. The token is used to confirm whether the client server 20 is authenticated. The token is known for a data coordination technique for UMA or the like and will not be described in detail.

The token issuer 54 associates the issued token with the command information and causes the issued token to be stored in the token information 63 stored in the storage unit 12, for example. Then, the token issuer 54 may use a known token generation method for UMA to generate the token, for example. The token information 63 is described later.

The token issuer 54 extracts basic information of the client from the basic information 64 stored in the storage unit 12.

The token verifier 55 verifies whether a token transmitted by the client server 20 is the same as the token generated by the token issuer 54. In this case, the token verifier 55 may reference the token information 63 and execute the verification.

The consent information 60, the user policy information 61, the ticket information 62, the token information 63, the basic information 64, and the user information 65, which are stored in the storage unit 12, are described below.

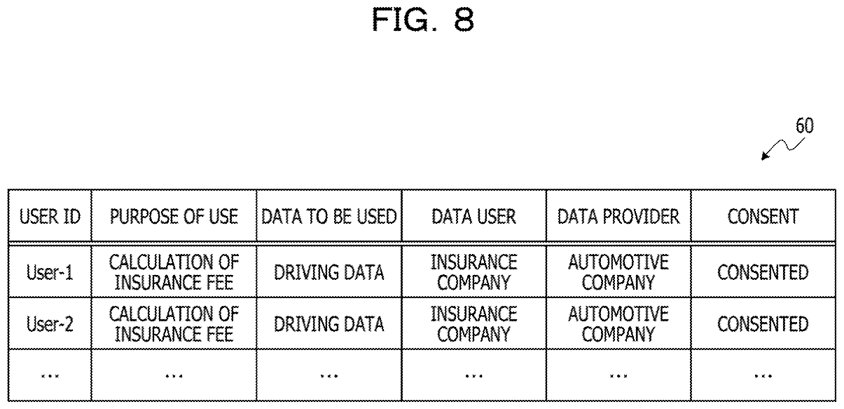

The consent information 60 is used to manage whether the user agrees on the contract between the user and the client (data user) regarding the handling of the personal data of the user. In the embodiment, the consent information 60 stores information indicating whether the user agrees that the personal data of the user is disclosed to the client. The information stored in the consent information 60 is described later with reference to FIG. 8.

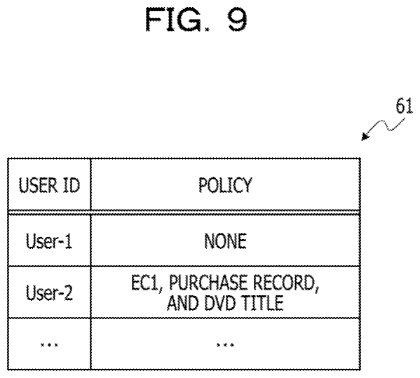

The user policy information 61 is used to manage the access control policy (described later) registered by the user using the user terminal 40. In the embodiment, the user policy information 61 stores information that is included in the personal data of the user and that the user does not want to disclose to the client (data user). The information stored in the user policy information 61 is described later with reference to FIG. 9.

The ticket information 62 is used to manage a ticket generated by the ticket issuer 52 and transmitted (Issued) by the ticket issuer 52 to the resource server 30. The ticket information 62 may be used to manage information that is related to the ticket generated and transmitted by the ticket issuer 52 and has been associated with the identifier (ID) of the session and the information of the client server 20.

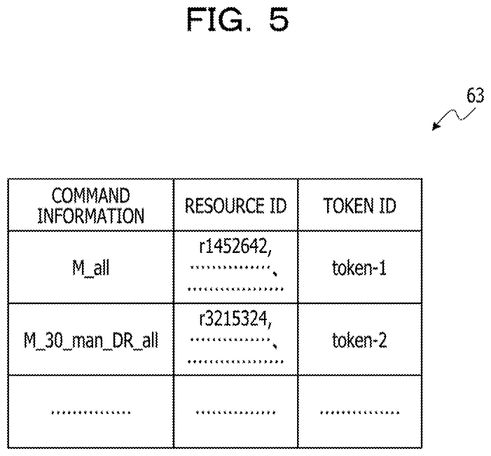

The token information 63 is used to manage a token generated by the token issuer 54 and transmitted (issued) by the token issuer 54 to the client server 20. The token information 63 may be used to manage command information (described later) associated with information related to the token generated and transmitted by the token issuer 54 and a resource ID (described later) managed by the resource server 30. A configuration of the token information 63 is described later with reference to FIG. 5. The information stored in the token information 63 is described later.

FIG. 5 exemplifies the token information 63 held in the consent portal server 10 in the information processing system 1 as the example of the embodiment.

The token information 63 exemplified in FIG. 5 includes a “command information” field, a “resource ID” field, and a “token ID” field.

The “command information” field of the token information 63 stores command information acquired by the command information analyzer 51. For example, the “command Information” field stores “M_all”.

The “resource ID” field of the token information 63 stores an identifier (ID) of a user identified by the “command Information” field. For example, when a request to acquire data on all users is provided or command information indicates “M_all” or the like, IDs of all the target users are stored in the “resource ID” field. Resource IDs are described later.

The “token ID” field of the token information 63 stores information uniquely identifying a token. A value stored in the “token ID” field may indicate an identifier (for example, “token-1”) uniquely identifying the token or may be a token value issued by the token issuer 54.

In the phase 1 (described later), a request for meta information is processed and thus does not include information on a target user. Thus, in the embodiment, in the phase 1, “NULL” is stored in the “resource ID” field of the token information 63.

The basic information 64 is used to manage information (item) that the client wants to acquire from the resource server 30. The basic information 64 may be used to manage information that the client wants to acquire for each resource server 30. Alternatively, the basic information 64 may be set by the client in advance. The basic information 64 may be changed by the client at any time.

The user information 65 is used to manage a user ID (described later) and a resource ID (described later) for each of users, while the user IDs are associated with the resource IDs in the user information 65. The user information 65 also includes information of the resource server 30 that manages the resource IDs.

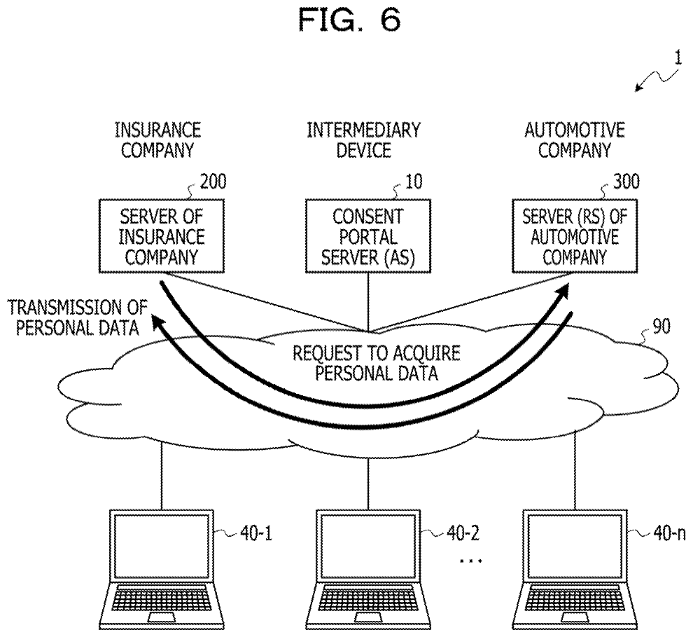

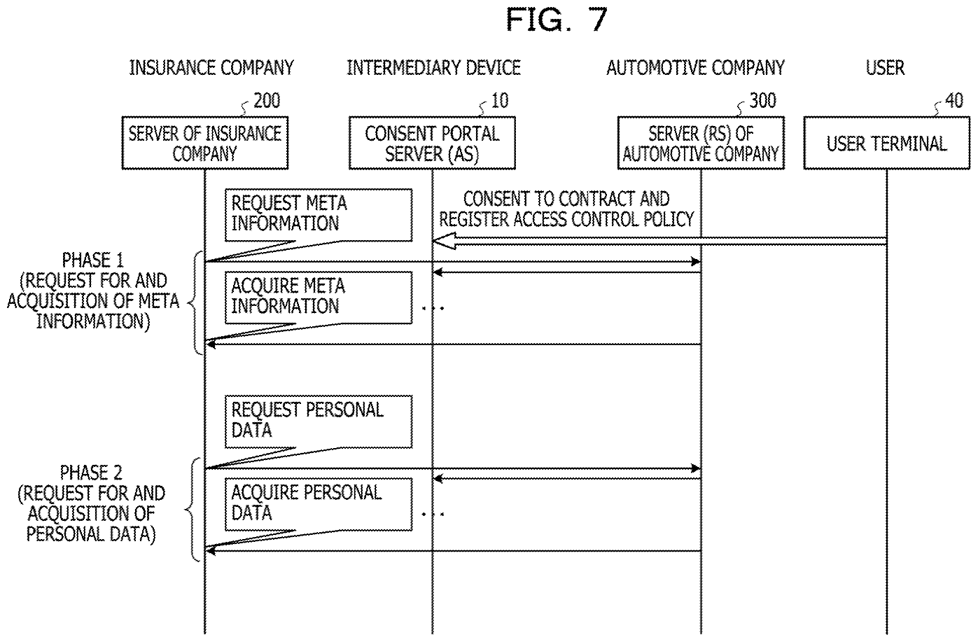

As an example of the embodiment, an overview of a process of controlling the acquisition of personal data in the information processing system 1 configured as described above is described based on a sequence chart illustrated in FIG. 7 with reference to FIG. 6.

FIG. 6 is a diagram exemplifying an overview of the control process to be executed in the information processing system 1 as the example of the embodiment. FIG. 7 is a sequence chart illustrating the overview of the process, exemplified in FIG. 6, of controlling the acquisition of personal data in the information processing system 1.

FIG. 6 exemplifies the case where an insurance company requests an automotive company to provide personal data related to the latest insurance policyholder and included in personal data owned by the automotive company and the automotive company transmits the personal data to the insurance company in response to the request. The insurance company described with reference to FIG. 6 corresponds to the data user illustrated in FIG. 1, and a server 200 of the insurance company described with reference to FIG. 6 corresponds to the client server 20 illustrated in FIG. 1. The automotive company described with reference to FIG. 6 corresponds to the data provider illustrated in FIG. 1, and a server 300 of the automotive company described with reference to FIG. 6 corresponds to the resource server 30 illustrated in FIG. 1. Similarly to the case illustrated in FIG. 1, the consent portal server (AS) 10 exemplified in FIG. 6 mediates data coordination between the server 200 of the insurance company and the server 300 of the automotive company.

To enable the aforementioned data coordination exemplified in FIG. 6, control exemplified in FIG. 7 is executed in the information processing system 1 as the example of the embodiment.

As exemplified in FIG. 7, the control is executed in the two phases 1 and 2 in the information processing system 1.

In the phase 1, the server 200 of the insurance company requests the server 300 of the automotive company to transmit meta information (described later), and the server 300 of the automotive company transmits the meta information of the automotive company to the server 200 of the insurance company in response to the request.

In the phase 2 that is executed after the phase 1, the server 200 of the insurance company requests the server 300 of the automotive company to transmit desired personal data. In addition, in the phase 2, the server 300 of the automotive company transmits the personal data to the server 200 of the insurance company in response to the request. FIGS. 6 and 7 exemplify a process of requesting personal data of the latest insurance policyholder from the server 200 of the insurance company to the server 300 of the automotive company.

As indicated by step A1 in FIG. 7, it is assumed that, before the process of the phase 1 is executed, the user agrees on a contract with the consent portal server 10 and already registers an access control policy. A process indicated by step A1 is executed on each of users.

The contract with the consent portal server 10 is consent entered into between the user and the insurance company regarding handling of the personal data of the user. The insurance company is a user of the personal data. In the embodiment, the contract with the consent portal server 10 is consent to disclosure of the personal data of the user to the insurance company. The consent to the contract defines whether the user agrees on the disclosure.

For example, in step A1, when a user having a user ID “User-1” agrees that personal data of the user is disclosed to the insurance company, the policy manager 50 of the consent portal server 10 causes information indicating the consent to be stored in the consent information 60 stored in the storage unit 12.

FIG. 8 is a diagram exemplifying the consent information 60 held in the information processing system 1 illustrated in FIG. 6 as the example of the embodiment. In the embodiment, as exemplified in FIG. 8, the consent information 60 is in a table format. Information stored in the consent information 60 may not be in the table format and may be in any of various formats.

The consent information 60 exemplified in FIG. 8 includes a “user ID” field, a “purpose of use” field, a “data to be used” field, a “data provider” field, and a “consent” field. FIG. 8 illustrates an example in which driving data owned by the automotive company that is the data provider is provided to the insurance company that is the data user in order to calculate an insurance fee based on the aforementioned contract. In the contract between the user and the insurance company that is the data user, consent to the calculation of the insurance fee may be made by providing, to the insurance company, the driving data owned by the automotive company that is the data provider.

The “user ID” field of the consent information 60 stores an identifier (ID) uniquely identifying a user. For example, the “user ID” field stores “User-1”. The embodiment assumes that the identifier is issued by the consent portal server 10.

The “purpose of use” field of the consent information 60 stores a purpose for which personal data of the user is used by the data user. For example, the “purpose of use” field stores “calculation of insurance fee”.

The “data to be used” field of the consent information 60 stores a type (detail) of data included in the personal data of the user and to be used by the data user. For example, the “data to be used” field stores “driving data”.

The “data user” field of the consent information 60 stores information indicating the data user (client) with which the user identified by the “user ID” field may agree. For example, the “data user” field stores “insurance company”. A value stored in the “data user” field may indicate the name of the data user (client) or may indicate an identifier uniquely identifying the data user (client).

The “data provider” field of the consent information 60 stores information indicating the data provider owning the personal data on the user identified by the “user ID” field. For example, the “data provider” field stores “automotive company”. A value stored in the “data provider” field may indicate the name of the data provider or may indicate an identifier uniquely identifying the data provider.

The “consent” field of the consent information 60 stores information indicating whether the user identified by the “user ID” field has consented to the data user (client) identified by the “data user” field. The embodiment assumes that, when the user has already consented to the data user (client), “consented” is stored in the “consent” field.

For example, the case where the user having the user ID “User-1” agrees that the personal data of the user is disclosed to the insurance company in step A1 illustrated in FIG. 7 is described below. In this case, the policy manager 50 of the consent portal server 10 causes, for example, “consented” to be stored in a cell included in the “consent” field and corresponding to the user ID “User-1” in the consent information 60 (refer to FIG. 8).

In step A1 illustrated in FIG. 7, the user registers the access control policy as well as the information indicating the consent to the aforementioned contract.

In the embodiment, the access control policy is information defining a restriction on access to the personal data. For example, the access control policy defines that, when information that is included in the personal data of the user and that the user does not want to disclose to the client server (server of the data user) 20 exists, the information is registered. In the embodiment, the information that is included in the personal data of the user and that the user does not want to disclose to the insurance company may be registered in the access control policy.

FIG. 9 is a diagram exemplifying the user policy information 61 held in the information processing system 1 illustrated in FIG. 6 as the example of the embodiment. In the embodiment, as exemplified in FIG. 9, the user policy information 61 is in a table format. Information stored in the user policy information 61 may not be in the table format and may be in any of various formats.

The user policy information 61 exemplified in FIG. 9 includes a “user ID” field and a “policy” field.

The “user ID” field of the user policy information 61 stores an identifier (ID) uniquely identifying a user. For example, the “user ID” field stores “001”. A value stored in the “user ID” field corresponds to a value stored in the “user ID” field of the aforementioned consent information 60 (refer to FIG. 8).

In the “policy” field of the user policy information 61, information that is included in the personal data of the user identified by the “user ID” field and that the user does not want to disclose to the client server 20 is registered. In the embodiment, when information that the user does not want to disclose to the client server 20 exists, the information is stored in the “policy” field. On the other hand, when the information that the user does not want to disclose to the client server 20 does not exist, “none” is stored in the “policy” field.

For example, the case where a user having a user ID “User-x” does not want to disclose a purchase record included in personal data of the user to the insurance company in step A1 illustrated in FIG. 7 is described below. In this case, the policy manager 50 of the consent portal server 10 causes, for example, “purchase record” to be stored in a cell included in the “policy” field and corresponding to the user ID “User-x” in the user policy information 61 (refer to FIG. 9).

When the user agrees on the access control policy in step A1 illustrated in FIG. 7, the consent portal server 10 execute control in the phases 1 and 2 illustrated in FIG. 7 based on the user policy information 61 exemplified in FIG. 9.

When the user does not consent to the access control policy in step A1 illustrated in FIG. 7, the consent portal server 10 does not execute the control in the phases 1 and 2 illustrated in FIG. 7, and the policy manager 50 may terminate the process.

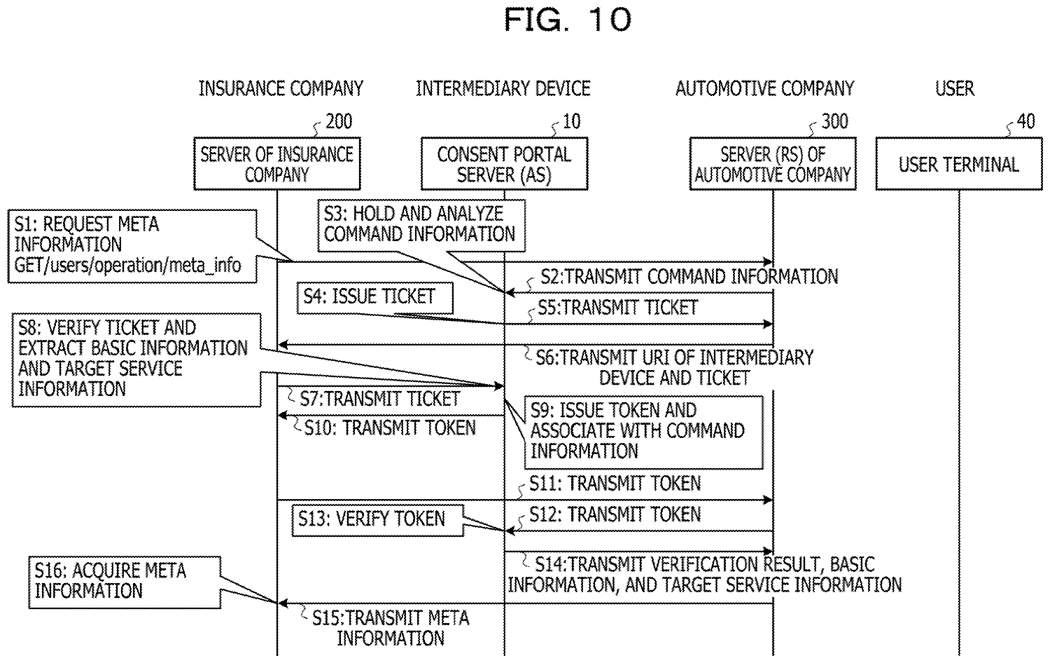

As an example of the embodiment, a control process of the phase 1 in the information processing system 1 is described based on a sequence chart (S1 to S16) illustrated in FIG. 10.

FIG. 10 is the sequence chart describing the aforementioned control process of the phase 1 illustrated in FIG. 7. A process of requesting meta information (described later) from the server 200 of the insurance company to the server 300 of the automotive company and acquiring the meta information from the server 300 of the automotive company is described with reference to FIG. 10.

The meta information according to the embodiment is described below. In the embodiment, the meta information includes filter information, held in the resource server 30, of the resource server 30 and a data format held in the resource server 30. The meta information may vary for each of resource servers 30. The filter information and the data format that are included in the meta information are described below.

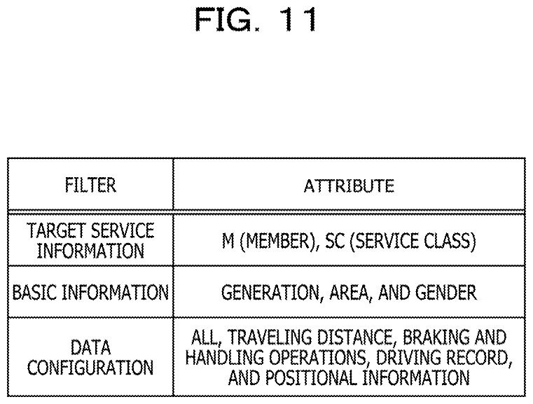

FIG. 11 exemplifies filter information held in the server 300, functioning as the resource server 30, of the automotive company in the information processing system 1 as the example of the embodiment.

The filter information exemplified in FIG. 11 includes a “filter” field and an “attribute” field.

The “filter” field of the filter information includes “target service information”, “basic information”, and a “data configuration” as an example. This indicates that personal data held in the server 300 (resource server 30) of the automotive company is classified into the target service information, the basic information, and driving information. For example, the server 200 of the insurance company may extract (filter) one or more of the target service information, the basic information, and the driving information among the personal data held in the server 300 of the automotive company and acquire personal data.

The “attribute” field of the filter information stores attributes identified by the “filter” field.

FIG. 11 exemplifies that “M” and “SC” exist as the attributes identified by the “target service information” filter. The attribute “M” represents a member and indicates that the server 200 of the insurance company may specify “M: member”, “M: all policyholders”, or the like, for example. Thus, the server 200 of the insurance company may acquire personal data of a member and personal data of all policyholders. In this case, the personal data of the member and the personal data of the policyholders are included in the personal data held in the server 300 of the automotive company. The attribute “M” (member) is described later in the following description of the phase 2.

The attribute “SC” exemplified in FIG. 11 represents a service class. An attribute value is set in the attribute “SC”, like the aforementioned attribute “M”. Thus, the server 200 of the insurance company may acquire personal data belonging to a desired service class.

FIG. 11 exemplifies that a “generation”, an “area”, and a “gender” exist as attributes identified by the “basic information” filter. For example, the server 200 of the insurance company may specify “generation: 30” and acquire personal data of members in their 30s from the server 300 of the automotive company. The “basic information” filter is described later in the following description of the phase 2.

FIG. 11 exemplifies that a “traveling distance”, “positional information”, and the like exist as attributes identified by the “data configuration” filter.

The data format included in the meta information including the aforementioned filter information includes, for example, a data item and a transfer format (for example, JavaScript Object Notation (JSON)) exist.

Next, a process of acquiring such meta information as described above in the phase 1 is described with reference to a sequence chart illustrated in FIG. 10.

In step S1, the server 200 of the insurance company requests the server 300 of the automotive company to transmit meta information. In this case, in the embodiment, as exemplified in FIG. 10, when a communication protocol based on Hypertext Transfer Protocol (HTTP) 1.1 is used, a GET command (“GET/users/operation/meta_info”) is used as a request message.

When the GET command is used, a character string “meta_info” that is the end of the GET command is referred to as command information or extraction information. The server 200 of the insurance company may specify “meta_info” as an argument or parameter of the GET command (for example, “GET/users/operation?meta_info”) and request the meta information.

In the embodiment, “meta_info” is set in the command information of the GET command in the phase 1, “M_all” is set in the command information of the GET command in the phase 2 described later, and a value set in the command information functions as a flag indicating a phase that is any of the phases 1 and 2 and is being executed.

In subsequent step S2, the server 300 of the automotive company transmits, to the consent portal server 10, the command information received in step S1 (to replace the command information). In this case, in the embodiment, the server 300 of the automotive company uses a POST command to transmit the command information.

In subsequent step 53, the command information analyzer 51 of the consent portal server 10 causes the acquired command information to be held (stored) in the token information 63.

In addition, the command information analyzer 51 analyzes the acquired command information. As described above, when the acquired command information is “meta_Info” as a result of the analysis of the command information, the command information analyzer 51 determines that the current process is in the phase 1, and processes of steps 54 and later illustrated in FIG. 10 (phase 1) are executed.

On the other hand, when the acquired command information is information (for example, M_all) other than “meta_info” as a result of the analysis of the acquired command information, the command information analyzer 51 determines that the current process is in the phase 2, and subsequent processes of the phase 2 are executed.

This is due to the fact that, since the processes of steps S1 and S2 of the phase 1 are similar to processes of steps T1 and T2 of the phase 2 (described later), except for the command information, whether the current process is in the phase 1 or the phase 2 is determined based on the command information.

In step S3, the command information analyzer 51 of the consent portal server 10 causes the acquired command information to be stored in the token information 63. In this case, the acquired command information is stored in the “command Information” field.

In step 54, the ticket issuer 52 of the consent portal server 10 generates (issues) a ticket. As described above, the ticket issuer 52 may use the known ticket generation method for UMA to generate the ticket.

In subsequent step S5, the ticket issuer 52 of the consent portal server 10 transmits the generated ticket to the server 300 of the automotive company.

Then, the ticket issuer 52 causes information on the transmitted ticket to be stored in the ticket information 62 stored in the storage unit 12, for example. In this case, the ticket issuer 52 may associate the information on the transmitted ticket with an identifier (ID) of a session between the consent portal server 10 and the server 300 of the automotive company and the information of the client server 20 and cause the information on the transmitted ticket to be stored in the ticket information 62.

In subsequent step S6, the server 300 of the automotive company transmits the ticket received in step S5 and a uniform resource identifier (URI) of the consent portal server 10 to the server 200 of the insurance company.

In subsequent step 57, the server 200 of the insurance company transmits the ticket received in step 56 to the consent portal server 10. In this case, the URI, transmitted in step 56, of the consent portal server 10 may be specified as a destination of the ticket.

In subsequent step 58, the ticket verifier 53 of the consent portal server 10 verifies whether the ticket transmitted by the server 200 of the insurance company is the same as the ticket generated in the aforementioned step S4. In this case, the ticket verifier 53 may reference the ticket information 62 and execute the verification.

In step S8, the ticket verifier 53 verifies whether the ticket generated by the ticket issuer 52 in the aforementioned step 54 and transmitted to the server 300 of the automotive company in the aforementioned step 55 matches the ticket transmitted by the server 200 of the insurance company in the aforementioned step S7. When the ticket verifier 53 verifies that the tickets do not match, the ticket verifier 53 may terminate the process.

The token issuer 54 of the consent portal server 10 extracts basic information of the insurance company and target service information of the insurance company from the basic information 64 stored in the storage unit 12.

As described above, the basic information of the insurance company and the target service information of the insurance company are information that the insurance company that is the data user wants to acquire from the automotive company that is the data provider. The basic information of the insurance company and the target service information of the insurance company are also referred to as requested data items. In this case, the basic information of the insurance company includes, for example, a generation, an area, and a gender. The target service information is information that the insurance company wants to acquire from the automotive company. In addition, the target service information of the insurance company includes a member and a service class.

In subsequent step 59, the token issuer 54 generates a token. As described above, the token issuer 54 may use the known token generation method for UMA to generate the token, for example.

Then, the token issuer 54 associates the generated token with the command information held and analyzed in the aforementioned step S3 and causes the token to be stored in the token information 63 stored in the storage unit 12, for example.

In subsequent step S10, the token issuer 54 of the consent portal server 10 transmits the token generated in the aforementioned step S9 to the server 200 of the insurance company.

In subsequent step 511, the server 200 of the insurance company transmits the token transmitted in the aforementioned step S10 to the server 300 of the automotive company.

In subsequent step S12, the server 300 of the automotive company transmits the token transmitted in the aforementioned step S11 to the consent portal server 10 in order to verify the token.

In subsequent step 513, the token verifier 55 of the consent portal server 10 verifies the validity of the token transmitted in the aforementioned step 512 or transmitted from the server 200 of the insurance company to the server 300 of the automotive company. In this case, the token verifier 55 may reference the token information 63 and execute the verification.

In step S13, the token verifier 55 verifies whether the token generated in the aforementioned step S9 and transmitted to the server 200 of the insurance company matches the token transmitted by the server 300 of the automotive company in the aforementioned step S12.

In subsequent step 514, the token verifier 55 transmits a result of executing the verification in the aforementioned step S13 to the server 300 of the automotive company. When the token issuer 55 determines that the tokens match as a result of executing the verification in the aforementioned step S13, the token verifier 55 transmits a verification result indicating, for example, “OK” to the server 300 of the automotive company.

In step S14, the token verifier 55 transmits the verification result, the basic information, extracted in step 58, of the insurance company, and the target service information, extracted in the aforementioned step S8, of the insurance company.

When the server 300 of the automotive company receives the verification result indicating that the tokens match in step S14, the consent portal server 10 has received the token via the server 300 of the automotive company from the valid client (insurance company) in step 512. Thus, when the server 300 of the automotive company receives the verification result indicating that the tokens match in step 514, processes of subsequent steps S15 and later are executed. The meta information, therefore, is transmitted by the server 300 of the automotive company to the server 200 of the insurance company.

On the other hand, when the server 300 of the automotive company receives the verification result indicating that the tokens do not match in step S14, the process may be terminated.

In step S15, the server 300 of the automotive company transmits the meta information as a response message to the server 200 of the insurance company.

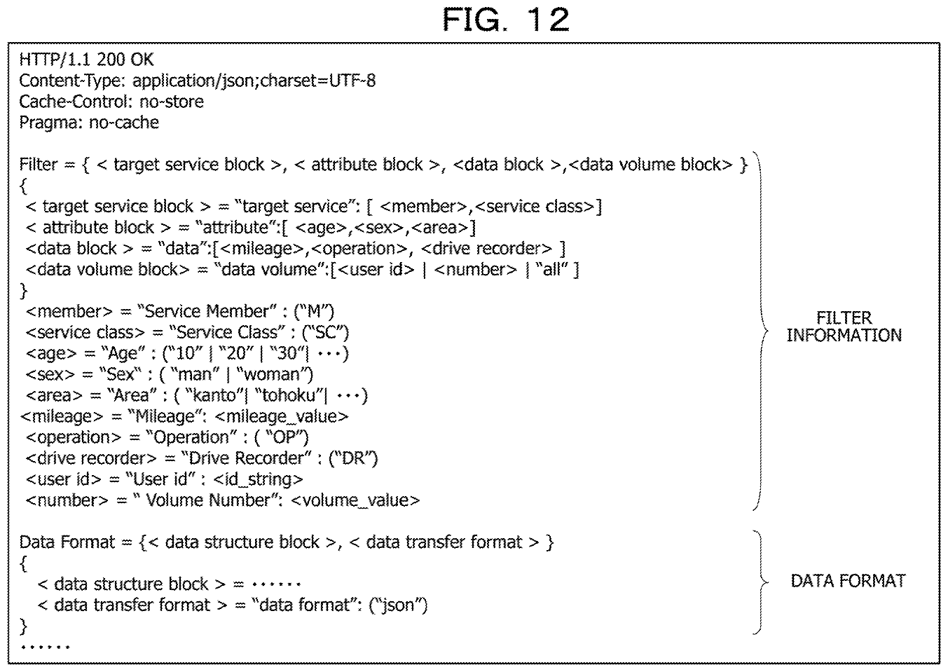

FIG. 12 exemplifies the response message to be used in the information processing system 1 as the example of the embodiment. As exemplified in FIG. 12, the response message includes filter information and a data format.

In step S15, the server 300 of the automotive company may cause the meta information to include information corresponding to the basic information, transmitted in the aforementioned step S14, of the insurance company and the target service information, transmitted in step S14, of the insurance company and may transmit the response message illustrated in FIG. 12 to the server 200 of the insurance company, for example. Alternatively, the basic information of the insurance company and the target service information of the insurance company may be stored in a storage device (not illustrated) included in the server 300 of the automotive company or the like.

As described above, the basic information of the insurance company and the target service information of the insurance company are information that the insurance company that is the data user wants to acquire from the automotive company that is the data provider. The server 300 of the automotive company receives the basic information of the insurance company and the target service information of the insurance company in the aforementioned step S14 and may transmit the meta information corresponding to the information desired by the insurance company to the insurance company.

In subsequent step 516, the server 200 of the insurance company acquires the meta information from the server 300 of the automotive company.

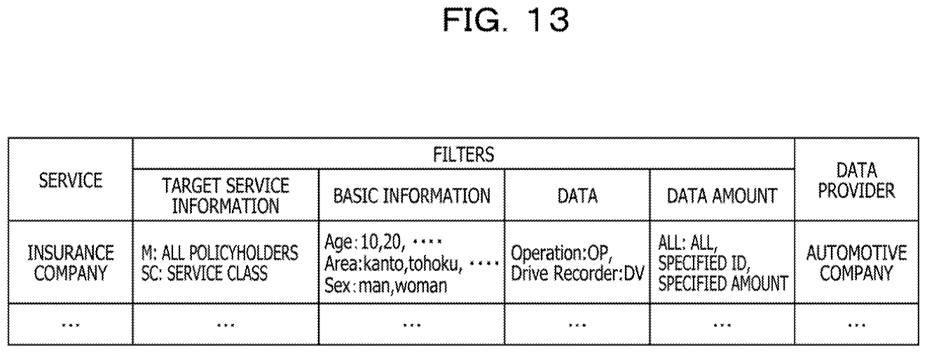

FIG. 13 exemplifies filter information managed by the server 200, functioning as the client server 20, of the insurance company in the information processing system 1 as the example of the embodiment.

The server 200 of the insurance company may use the meta information acquired in step S16 to update the filter information managed by the server 200, as exemplified in FIG. 13.

After the processes of the phase 1 (steps S1 to S16) illustrated in FIG. 10, the server 200 of the insurance company, which is the data user, acquires the meta information held in the server 300 of the automotive company from the server 300 of the automotive company, which is the data provider. The processes of the phase 1 may not be executed every time a process of acquiring personal data in the phase 2 (described later) is executed. For example, the processes of the phase 1 may be executed periodically (for example, once a day).

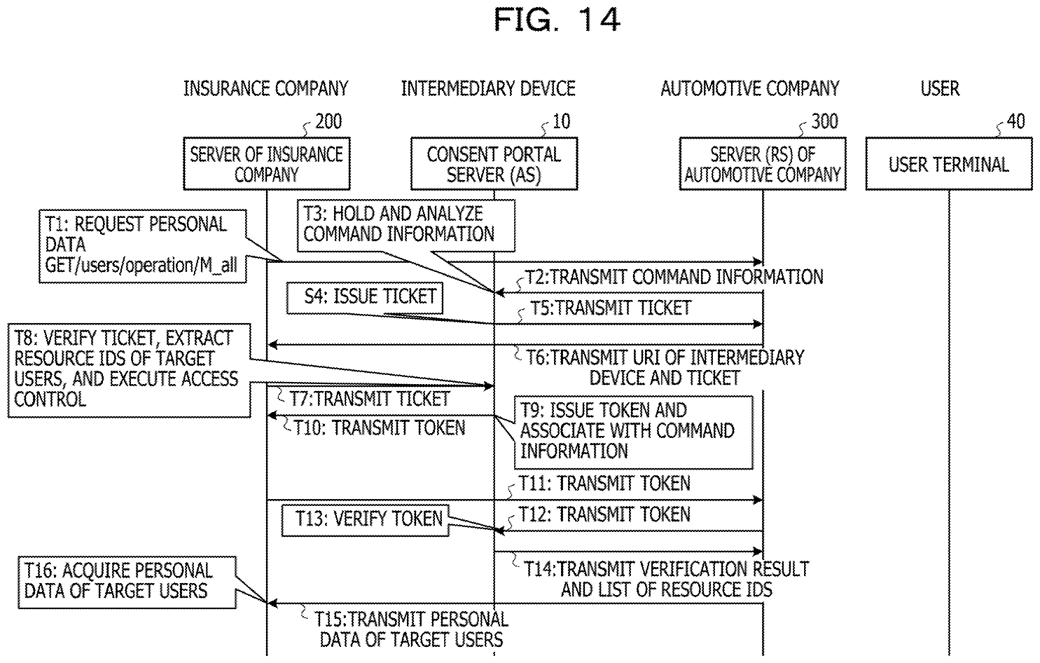

As an example of the embodiment, a control process of the phase 2 in the information processing system 1 is described based on a sequence chart (T1 to T16) illustrated in FIG. 14.

FIG. 14 is a sequence chart describing the control process of the phase 2 illustrated in FIG. 7. A process of requesting personal data on a desired user from the server 200 of the insurance company to the server 300 of the automotive company and acquiring the personal data from the server 300 of the automotive company is described using FIG. 14.

In step T1, the server 200 of the insurance company requests the server 300 of the automotive company to transmit personal data. In this case, the server 200 of the insurance company treats all users as target users and requests the personal data of all the users as an example. In the embodiment, as exemplified in FIG. 14, when the communication protocol based on Hypertext Transfer Protocol (HTTP) 1.1 is used, a GET command (“GET/users/operation/M_all”) is used, for example. The server 200 of the insurance company may specify “M_all” as an argument or parameter of the GET command (for example, “GET/users/operation?M_all”) and request the personal data.

In this manner, command information of the GET command is set to “M_all” in the phase 2.

In subsequent step T2, the server 300 of the automotive company acquires the command information “M_all” from the GET command received from the server 200 of the insurance company.

Then, the server 300 of the automotive company transmits the command information received in step T1 to the consent portal server 10 (to replace the command information). In this case, in the embodiment, the server 300 of the automotive company uses a POST command to transmit the command information.

In subsequent step T3, the command information analyzer 51 of the consent portal server 10 causes the acquired command information to be stored in the “command information” held of the token information 63.

In addition, the command information analyzer 51 analyzes the acquired command information. As described above, the acquired command information is “M_all” as a result of the analysis of the command information.

Thus, the command information analyzer 51 determines that the current process is in the phase 2, and subsequent processes (of steps T4 and later) of the phase 2 are executed.

In subsequent step T4, the ticket issuer 52 of the consent portal server 10 generates (issues) a ticket.

In subsequent step T5, the ticket issuer 52 of the consent portal server 10 transmits the generated ticket to the server 300 of the automotive company.

Then, the ticket issuer 52 causes information on the transmitted ticket to be stored in the ticket information 62 stored in the storage unit 12, for example.

In subsequent step T6, the server 300 of the automotive company transmits the ticket received in step T5 and the URI of the consent portal server 10 to the server 200 of the insurance company.

In subsequent step T7, the server 200 of the insurance company transmits the ticket received in step T6 to the consent portal server 10. In this case, the URI, transmitted in step T6, of the consent portal server 10 may be specified as a destination of the ticket.

In subsequent step T8, the ticket verifier 53 of the consent portal server 10 verifies whether the ticket transmitted by the server 200 of the insurance company is the same as the ticket generated in the aforementioned step T4.

In step T8, the policy manager 50 of the consent portal server 10 references the user policy information 61 stored in the storage unit 12 and confirms, for each of the users (target users) of which the personal data is to be acquired, whether the user has already consented that personal data of the user is disclosed. The target users of which the personal data is to be acquired may be determined based on the command information acquired in the aforementioned step T3.

Then, the policy manager 50 references the user information 65 and acquires (extracts) a resource ID for each of users confirmed to have consented. The resource IDs are identifiers (IDs) uniquely identifying the users and are issued and managed by the resource server 30 for each of the users. Since user IDs are issued by the consent portal server 10 as described above, a user ID assigned to each of the users may be different from a resource ID assigned to the user. In the user information 65, a user ID and a resource ID are managed in association with each other for each of the users.

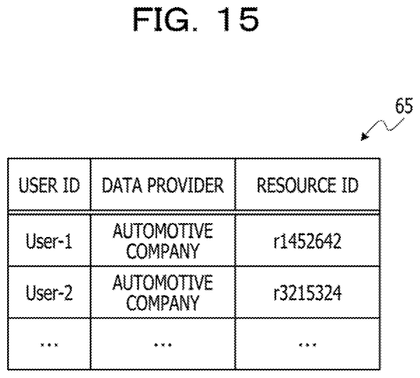

FIG. 15 is a diagram exemplifying the user information 65 held in the information processing system 1 illustrated in FIG. 6 as the example of the embodiment. In the embodiment, as exemplified in FIG. 15, the user information 65 is in a table format. Information stored in the user information 65 may not be in the table format and may be in any of various formats.

The user information 65 exemplified in FIG. 15 includes a “user ID” field, a “data provider” field, and a “resource ID” field.

The “user ID” field of the user information 65 stores an identifier (ID) uniquely identifying a user. For example, the “user ID” field stores “User-1”. The embodiment assumes that the identifier is issued by the consent portal server 10.

The “data provider” field of the user information 65 stores information indicating the data provider owning personal data on the user identified by the “user ID” field. For example, the “data provider” field stores “automotive company”. A value stored in the “data provider” field may indicate the name of the data provider or may indicate an identifier uniquely identifying the data provider.

The “resource ID” field of the user information 65 stores an identifier (ID) assigned by the resource server 30 identified by the “data provider” field to the user identified by the “user ID” field. In the “resource ID” field, “r1452642” is stored, for example.

The user information 65 includes the resource IDs managed by the resource server 30. Thus, in the embodiment, before the start of the control process of the phase 2, the token information 63 held in the consent portal server 10 is synchronized with the resource IDs managed by the resource server 30. The time when the synchronization is executed, however, is not limited to this.

Return to the description of the sequence chart illustrated in FIG. 14. In step T8, the policy manager 50 references the user information 65, acquires (extracts) the resource IDs of the users, and causes the acquired resource IDs to be stored in the token information 63. In this case, when multiple target users exist, resource IDs of the users may be coupled to each other using a comma “,” and stored in the token information 63 (refer to FIG. 5).

In step T8, the policy manager 50 of the consent portal server 10 references the user policy information 61 illustrated in FIG. 9 and executes access control. For example, the policy manager 50 may execute the access control after confirming whether a user who is among the target users and does not want to disclose personal data of the user exists.

In subsequent step T9, the token issuer 54 of the consent portal server 10 generates a token. A validity period of the token is set to a value shorter than a valid period in the case where user data of one user is acquired in consideration of safety. In addition, for example, the number of times that the token is used may be limited or may be limited to, for example, 1. The number of times that the token is used may be changed based on a service or data to be used.

Then, the token issuer 54 associates the generated token with the command information held and analyzed in the aforementioned step T3 and causes the token to be stored in the token information 63 stored in the storage unit 12.

In subsequent step T10, the token issuer 54 transmits (issues) the token generated in the aforementioned step T9 to the server 200 of the insurance company.

In subsequent step T11, the server 200 of the insurance company transmits the token transmitted in the aforementioned step T10 to the server 300 of the automotive company.

In subsequent step T12, the server 300 of the automotive company transmits the token transmitted in the aforementioned step T11 to the consent portal server 10 in order to verify the token.

In subsequent step T13, the token verifier 55 of the consent portal server 10 verifies the validity of the token transmitted in the aforementioned step T12 or transmitted from the server 200 of the insurance company to the server 300 of the automotive company.

In subsequent step T14, the token verifier 55 transmits a result of executing the verification in the aforementioned step T13 to the server 300 of the automotive company.

In this case, in step T14, the token verifier 55 transmits the verification result and the resource IDs (or a list of the resource IDs), extracted in the aforementioned step T8, of the target users to the server 300 of the automotive company.

When the server 300 of the automotive company receives the verification result indicating that the tokens match in step T14, the consent portal server 10 has received the token via the server 300 of the automotive company from the valid client (insurance company) in step T12. Thus, when the server 300 of the automotive company receives the verification result indicating that the tokens match in step T14, processes of subsequent steps T15 and later are executed. The personal data of the target users, therefore, is transmitted by the server 300 of the automotive company to the server 200 of the insurance company.

In subsequent step T15, the server 300 of the automotive company transmits the personal data of the target users to the server 200 of the insurance company.

In subsequent step T16, the server 200 of the insurance company acquires the personal data of the target users from the server 300 of the automotive company.

As described above, in the phase 2, personal data of multiple users may be provided to the client at one time.

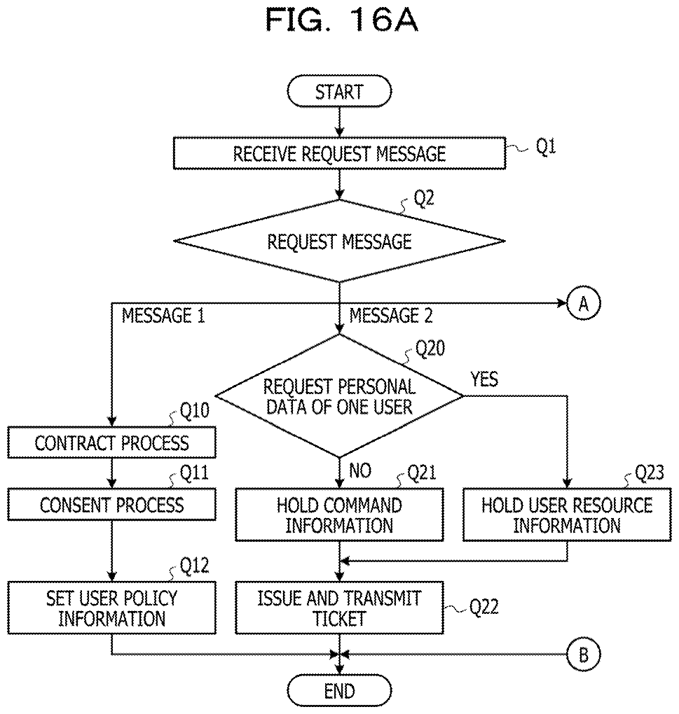

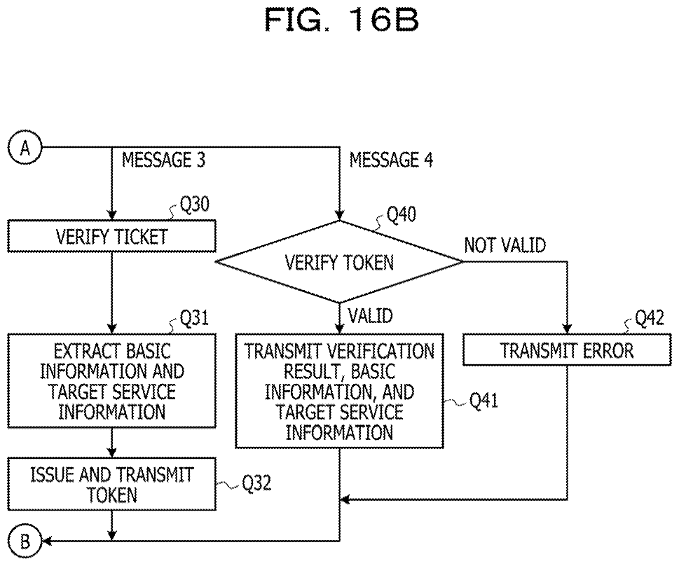

As an example of the embodiment, the control process of the phase 1 in the information processing system 1 is described below based on a flowchart (steps Q1, Q2, Q10 to Q12, Q20 to Q23, Q30 to Q32, and Q40 to Q42) Illustrated in FIGS. 16A and 16B.

FIGS. 16A and 16B are a flowchart describing the aforementioned control process (sequence chart) of the phase 1 illustrated in FIG. 10. A process of requesting meta information (described later) from the server 200 of the insurance company to the server 300 of the automotive company and acquiring the meta information from the server 300 of the automotive company is described with reference to FIGS. 16A and 16B.

In step Q1, the consent portal server 10 receives a request message from a user terminal 40 among the user terminals 40, the server 200 of the insurance company, or the server 300 of the automotive company.

When the request message received in the aforementioned step Q1 is based on a contract or consent transmitted from the user terminal 40 in subsequent step Q2, the process proceeds to step Q10 (refer to a route indicated by “message 1” in step Q2).

In step Q10, the policy manager 50 of the consent portal server 10 executes a contract process on the contract with a user that has transmitted the request message received in the aforementioned step Q1. For example, the policy manager 50 executes a process of presenting (displaying) a contract document to the user terminal 40 of the user.

In step Q11, the policy manager 50 receives, from the user terminal 40, a response indicating consent to the contract document presented in the aforementioned step Q10 and executes a consent process based on the response. In the embodiment, the policy manager 50 causes information indicating that the user has “consented” to be stored in the consent information 60.

In subsequent step Q12, the policy manager 50 sets, in the user policy information 61, information on a restriction on access to personal data of the user who has consented in the aforementioned step Q11. For example, in the embodiment, when information that is included in the personal data of the user and that the user does not want to disclose to the client server (server of the data user) 20 exists, the policy manager 50 registers the information in the user policy information 61. Then, the policy manager 50 terminates the contract process and the consent process.

When the request message received in the aforementioned step Q1 is command information transmitted by the server 300 of the automotive company in step Q2, the process proceeds to step Q20 (refer to a route indicated by “message 2” in step Q2).

When the command information received by the consent portal server 10 in the aforementioned step Q2 indicates a request to transmit personal data of many users in step Q20, the process proceeds to step Q21 (refer to a route indicated by NO in step Q20).

When the command information received by the consent portal server 10 in the aforementioned step Q2 indicates a request to transmit personal data of one user in step Q20, the process proceeds to step Q23 (refer to a route indicated by YES in step Q20).

In step Q21, the command information analyzer 51 of the consent portal server 10 holds the command information (request message) received in the aforementioned step Q1.

In subsequent step Q22, the ticket issuer 52 of the consent portal server 10 generates (issues) a ticket. Then, the ticket issuer 52 transmits the generated ticket to the server 300 of the automotive company. Then, the ticket issuer 52 terminates the process.

In step Q23, the consent portal server 10 uses a known UMA-based method to acquire and hold user resource information. Then, the process proceeds to step Q22.

When the request message received in the aforementioned step Q1 is a ticket transmitted by the server 200 of the insurance company in step Q2, the process proceeds to step Q30 (refer to a route indicated by “message 3” in step Q2).

In step Q30, the ticket verifier 53 of the consent portal server 10 verifies whether the ticket (request message) received in the aforementioned step Q1 is the same as the ticket issued and transmitted by the ticket issuer 52 in the aforementioned step Q22.

When the ticket verifier 53 determines that the tickets are the same (or are valid) in step Q30, the process proceeds to step Q31.

In subsequent step Q31, the token issuer 54 of the consent portal server 10 extracts the basic information of the insurance company and the target service information of the insurance company from, for example, the basic information 64 stored in the storage unit 12. Then, the process proceeds to step Q32.

In subsequent step Q32, the token issuer 54 generates a token. Then, the token issuer 54 transmits the generated token to the server 200 of the insurance company. Then, the ticket verifier 53 terminates the process.

When the request message received in the aforementioned step Q1 is a token transmitted by the server 200 of the insurance company in step Q2, the process proceeds to step Q40 (refer to a route indicated by “message 4” in step Q2).

In step Q40, the token verifier 55 of the consent portal server 10 verifies whether the token (request message) received in the aforementioned step Q1 is the same as the token generated and transmitted by the token issuer 54 in the aforementioned step Q32.

When the token verifier 55 determines that the tokens are the same or valid in step Q40, the process proceeds to step Q41 (refer to a route indicated by “valid” in step Q40).

On the other hand, when the token verifier 55 determines that the tokens are not the same or not valid in step Q40, the process proceeds to step Q42 (refer to a route indicated by “not valid” in step Q40).

In step Q41, the token verifier 55 transmits, to the server 300 of the automotive company, a result of executing the verification in the aforementioned step Q40, the basic information, extracted in the aforementioned step Q31, of the insurance company, and the target service information, extracted in step Q31, of the insurance company. Then, the token verifier 55 terminates the process.

In step Q42, the token verifier 55 transmits, to the server 300 of the automotive company, an error as the result of executing the verification in the aforementioned step Q40. Then, the token verifier 55 terminates the process.

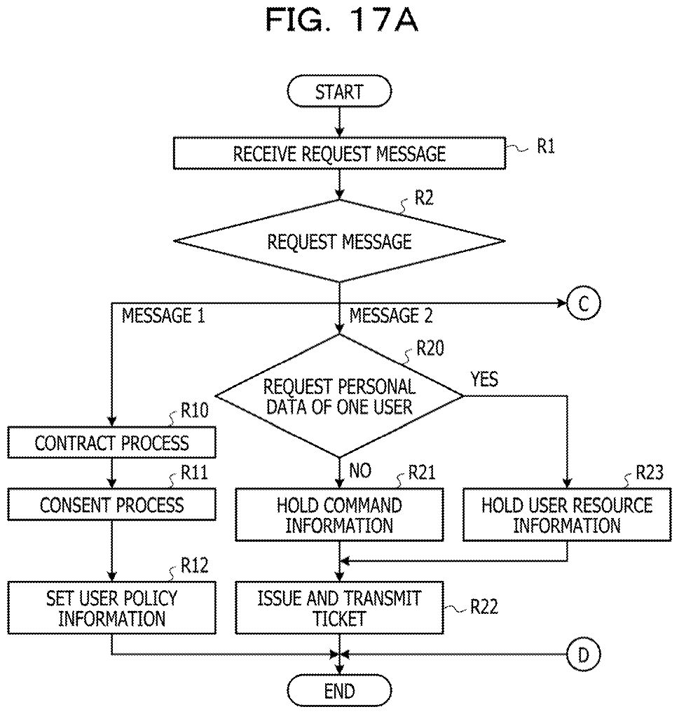

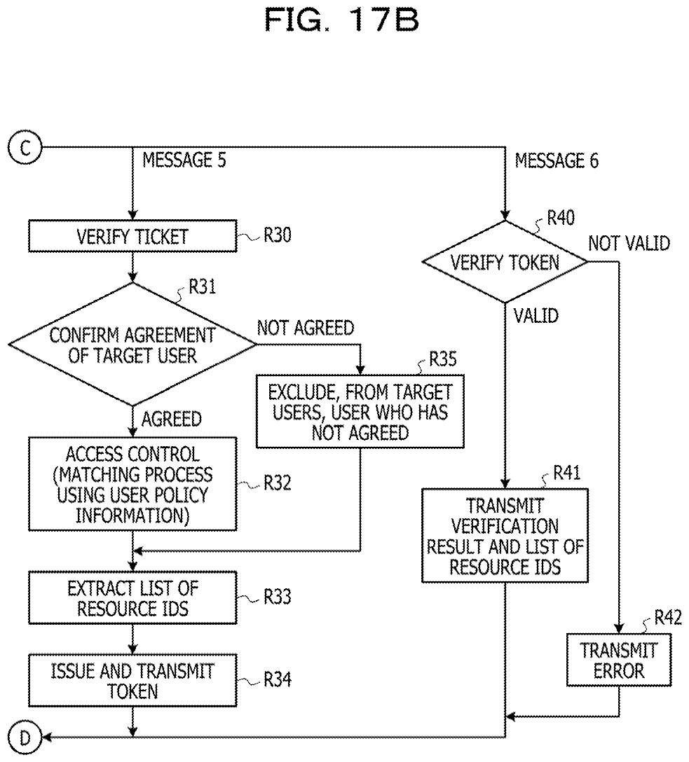

As an example of the embodiment, the control process of the phase 2 in the information processing system 1 is described below based on a flowchart (steps R1, R2, R10 to R12, R20 to R23, R30 to R35, and R40 to R42) illustrated in FIGS. 17A and 17B.

FIGS. 17A and 17B are a flowchart describing the aforementioned control process (sequence chart) of the phase 2 illustrated in FIG. 14. A process of requesting personal data on a desired user from the server 200 of the insurance company to the server 300 of the automotive company and acquiring the personal data from the server 300 of the automotive company is described with reference to FIGS. 17A and 17B.

In step R1, the consent portal server 10 receives a request message from a user terminal 40 among the user terminals 40, the server 200 of the insurance company, or the server 300 of the automotive company.

When the request message received in the aforementioned step R1 is based on a contract or consent transmitted by a user in subsequent step R2, the process proceeds to step R10 (refer to a route indicated by “message 1” in step R2). Then, the consent portal server 10 executes processes of steps R10 to R12. The processes of steps R10 to R12, however, are already described with reference to FIGS. 16A and 16B (steps Q10 to Q12) and will not be described.

When the request message received in the aforementioned step R1 is command information transmitted by the server 300 of the automotive company in step R2, the process proceeds to step R20 (refer to a route indicated by “message 2” in step R2). Then, the consent portal server 10 executes processes of steps R20 to R23. The processes of steps R20 to R23, however, are already described with reference to FIGS. 16A and 16B (steps Q20 to Q23) and will not be described.

On the other hand, when the request message received in the aforementioned step R1 is a ticket transmitted by the server 200 of the insurance company in step R2, the process proceeds to step R30 (refer to a route indicated by “message 5” in step R2).

In step R30, the ticket verifier 53 of the consent portal server 10 verifies whether the ticket (request message) received in the aforementioned step R1 is the same as a ticket generated and transmitted by the ticket issuer 52 in the aforementioned step R22.

When the ticket verifier 53 determines that the tickets are the same (or are valid) in step R30, the process proceeds to step R31.

In subsequent step R31, the policy manager 50 of the consent portal server 10 references the consent information 60 stored in the storage unit 12 and confirms, for each of users (target users of which personal data is to be acquired, whether the user has already consented that personal data of the user is disclosed.

When the policy manager 50 confirms that the target users (all the users) have consented in step R31, the process proceeds to step R32 (refer to a route indicated by “consented” in step R31).

On the other hand, when the policy manager 50 confirms that any of the target users has not consented in step R31, the process proceeds to step R35 (refer to a route indicated by “not consented” in step R31).

In step R32, the policy manager 50 references the user policy information 61 stored in the storage unit 12, acquires (extracts) resource IDs of the users, and executes the access control. For example, the policy manager 50 may execute the access control by confirming whether personal data that a user does not want to disclose exists based on the user policy information 61. Then, the process proceeds to step R33.

In step R35, the policy manager 50 excludes, from the target users, a user who has not consented. Then, the process proceeds to step R33.

In subsequent step R33, the policy manager 50 references the user information 65 and acquires (extracts) resource IDs of the users. Then, the process proceeds to step R34.

In subsequent step R34, the token issuer 54 of the consent portal server 10 generates a token and transmits (issues) the generated token to the server 200 of the insurance company. Then, the token issuer 54 terminates the process.

When the request message received in the aforementioned step R1 is a token transmitted by the server 200 of the insurance company in step R2, the process proceeds to step R40 (refer to a route indicated by “message 6” in step R2).

In step R40, the token verifier 55 of the consent portal server 10 verifies whether the token (request message) received in the aforementioned step R1 is the same as the token generated and transmitted by the token issuer 54 in the aforementioned step R34.

When the token verifier 55 determines that the tokens are the same or valid in step R40, the process proceeds to step R41 (refer to a route indicated by “valid” in step R40).

On the other hand, when the token verifier 55 determines that the tokens are not the same or not valid in step R40, the process proceeds to step R42 (refer to a route indicated by “not valid” in step R40).

In step R41, the token verifier 55 transmits, to the server 300 of the automotive company, a result of executing the verification in the aforementioned step R40 and the resource IDs (or a list of the resource IDs), extracted in the aforementioned step R33, of the target users. Then, the token verifier 55 terminates the process.

In step R42, the token verifier 55 transmits, to the server 300 of the automotive company, an error as the result of executing the verification in the aforementioned step R40. Then, the token verifier 55 terminates the process.

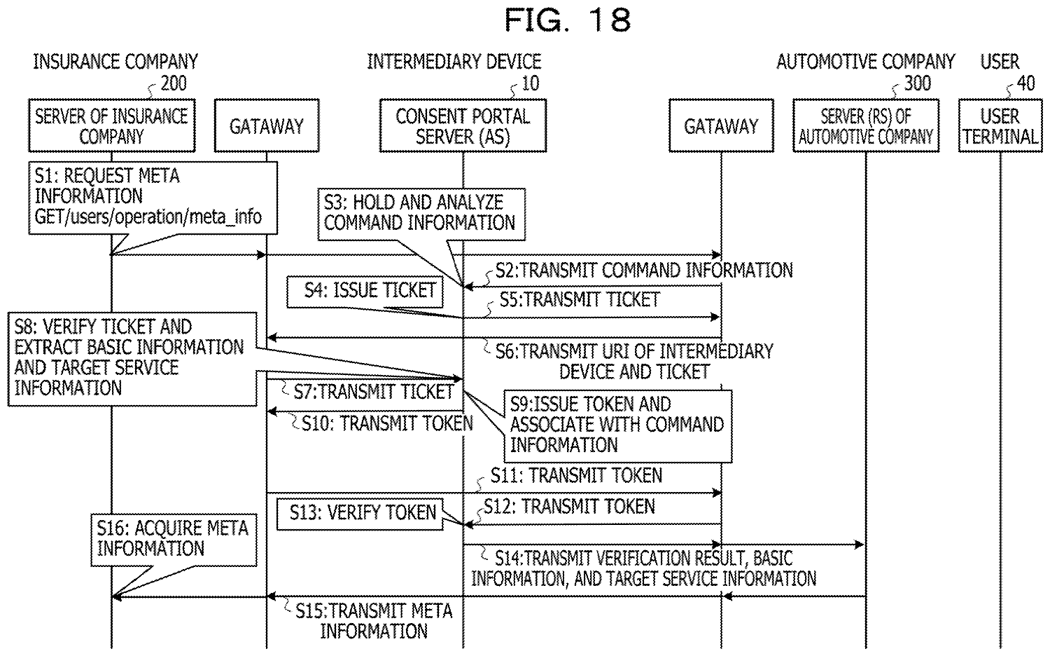

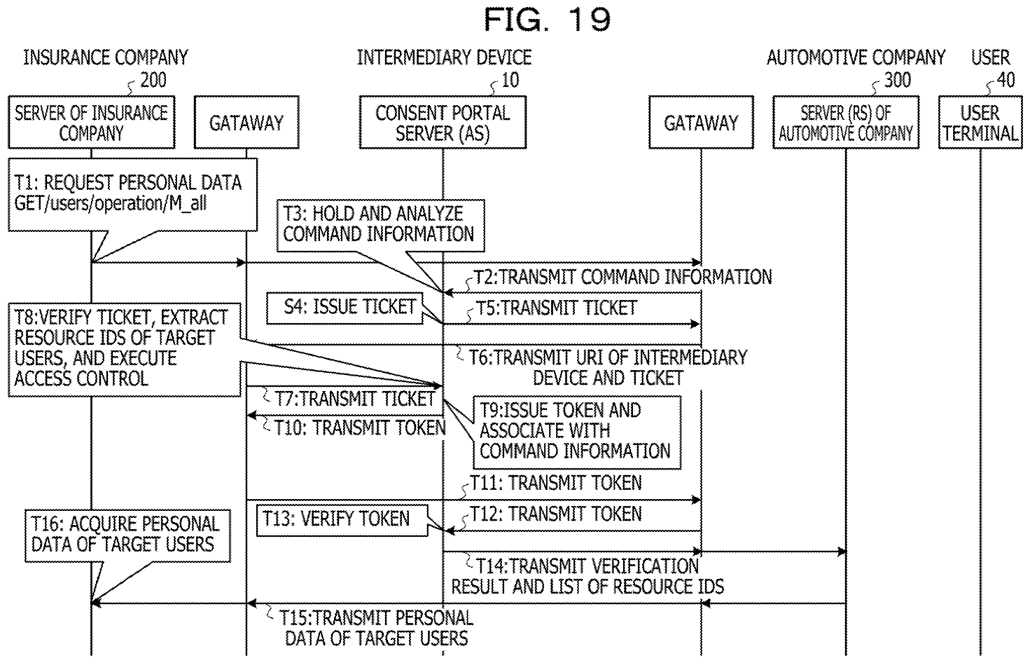

The control processes, which are executed by the consent portal server 10 in the case where the server 200 of the insurance company acquires information from the server 300 of the automotive company, are described with reference to the sequence charts illustrated in FIGS. 7, 10, and 14 and the flowcharts illustrated in FIGS. 16 and 17. The control processes, however, are not limited to this. For example, as exemplified in FIGS. 18 and 19, a gateway may be installed on the side of the insurance company, a gateway may be installed on the side of the automotive company, and the gateways may execute the processes on behalf of the server 200 of the insurance company and the server 300 of the automotive company. The gateway on the side of the insurance company is also referred to as gateway on the side of a first information processing device. The gateway on the side of the automotive company is also referred to as gateway on the side of a second information processing device.

In a modified example, the consent portal server 10 functions as an intermediary device for the gateway on the side of the insurance company and the gateway on the side of the automotive company.

FIG. 18 is a sequence chart describing a control process of a phase 1 in an information processing system 1 as the modified example.

As exemplified in FIG. 18, in step S1, the server 200 of the insurance company transmits a request to acquire meta information to the gateway on the side of the insurance company, and the gateway on the side of the insurance company transmits the request to the gateway on the side of the automotive company. Thus, the server 200 of the insurance company transmits the request to the gateway on the side of the automotive company via the gateway on the side of the insurance company. This feature is different from the aforementioned embodiment.

In the modified example, in a series of the processes of subsequent steps S2 to S15, the gateway on the side of the insurance company executes the processes (on behalf of the server 200 of the insurance company), which are executed by the server 200 of the insurance company in the series of the processes of steps S2 to S15 in the aforementioned embodiment.

Similarly, in the modified example, in the series of the processes of steps S2 to S15, the gateway on the side of the automotive company executes the processes (on behalf of the server 300 of the automotive company), which are executed by the server 300 of the automotive company in the series of the processes of steps S2 to S15 in the aforementioned embodiment.

In step S14, the token verifier 55 of the consent portal server 10 transmits the verification result, the basic information of the insurance company, and the target service information of the insurance company to the server 300 of the automotive company via the gateway on the side of the automotive company.

In step S15, the server 300 of the automotive company transmits the meta information of the automotive company to the gateway on the side of the insurance company via the gateway on the side of the automotive company.

In step S16, the gateway on the side of the insurance company acquires the meta information from the server 300 of the automotive company and transmits the acquired meta information to the server 200 of the insurance company. Thus, the server 300 of the automotive company transmits the meta information to the server 200 of the insurance company via the gateway on the side of the insurance company. This feature is different from the aforementioned embodiment.

FIG. 19 is a sequence chart describing a control process of a phase 2 in the information processing system 1 as the modified example.

As exemplified in FIG. 19, in step T1, the server 200 of the insurance company transmits a request to acquire personal data to the gateway on the side of the insurance company, and the gateway on the side of the insurance company transmits the request to the gateway on the side of the automotive company. Thus, the server 200 of the insurance company transmits the request to the gateway on the side of the automotive company via the gateway on the side of the insurance company. This feature is different from the aforementioned embodiment.

Then, in a series of the processes of subsequent steps T2 to T15, the gateway on the side of the insurance company executes the processes (on behalf of the server 200 of the insurance company), which are executed by the server 200 of the insurance company in the series of the processes of steps T2 to T15 in the aforementioned embodiment.

Similarly, in the series of the processes of steps T2 to T15, the gateway on the side of the automotive company executes the processes (on behalf of the server 300 of the automotive company), which are executed by the server 300 of the automotive company in the series of the processes of steps T2 to T15 in the aforementioned embodiment.

In step T14, the token verifier 55 of the consent portal server 10 transmits the verification result and the resource IDs (or the list of the resource IDs) to the server 300 of the automotive company via the gateway on the side of the automotive company.

Then, in step T15, the server 300 of the automotive company transmits the personal data of the automotive company to the gateway on the side of the insurance company via the gateway on the side of the automotive company.

In step T16, the gateway on the side of the insurance company acquires the personal data from the server 300 of the automotive company and transmits the acquired personal data to the server 200 of the insurance company. Thus, the server 300 of the automotive company transmits the personal data to the server 200 of the insurance company via the gateway on the side of the insurance company. This feature is different from the aforementioned embodiment.

As described above, in the modified example, the gateways execute the processes of steps on behalf of the server 300 of the automotive company and the server 200 of the insurance company, thereby reducing a load of the server 300 of the automotive company and a load of the server 200 of the insurance company. In addition, it may be possible to reduce the number of messages to be transmitted and received by the server 300 of the automotive company and the number of messages to be transmitted and received by the server 200 of the insurance company.

In each of the information processing systems 1 as the example of the embodiment and the modified example, the consent portal server 10 functioning as the intermediary device analyzes command information and extracts target users, thereby acquiring personal data on many users at one time. This may reduce the amount of messages to be transmitted.

In each of the information processing systems 1 as the example of the embodiment and the modified example, not only the phase 2 in which the process of requesting and acquiring personal data is executed but also the phase 1 in which meta information of a data provider is acquired are executed. This may inhibit meta information, which vary for each of data providers in many cases, from being defined for each of the data providers. In addition, the latest meta information may be acquired by executing the processes of the phase 1.

In each of the information processing systems 1 as the example of the embodiment and the modified example, the process of acquiring basic information and target service information of a data user is included in the processes of the phase 1. This may inhibit basic and target service information, varying for each of data users in many cases, of the data users from being defined for each of the data users. In addition, the latest basic information and the latest target service information of data users may be acquired by executing the processes of the phase 1.

In each of the information processing systems 1 as the example of the embodiment and the modified example, the replacement of the interfaces may be suppressed in the case where a system that uses UMA by defining the processes of the phases 1 and 2 based on UMA is changed to a system using each of the methods described in the embodiment and the modified example.

In the information processing system 1 as the modified example, the amounts of messages in the client server 20 and the resource server 30 may be reduced by installing the gateways for executing the processes of the client server 20 and the resource server 30 on behalf of the client server 20 and the resource server 30.

In the information processing system 1 as the modified example, the amount of messages to be transmitted and received between the client server 20 (server of the data user) and the gateway on the side of the data user may be small and the messages may be simple. Thus, an application for the client server 20 and the like may be easily developed without consideration of a protocol such as UMA, and a load of a message process executed in the application may be reduced.

In the information processing system 1 as the modified example, the amount of messages to be transmitted and received between the resource server 30 (server of the data provider) and the gateway on the side of the data provider may be small and the messages may be simple. Thus, an application for the resource server 30 and the like may be easily developed without consideration of a protocol such as UMA, and a load of a message process executed in the application may be reduced.

The techniques according to the aforementioned embodiment may be changed and modified as follows. In the embodiment and the modified example, in each of the information processing systems 1, the processes are classified into the phase 1 and the phase 2, but the phases 1 and 2 may be executed as a single process. In this case, the processes that are included in the phases 1 and 2 and are the same may be treated as a single process.

In the embodiment and the modified example, the consent information 60, the user policy information 61, the ticket information 62, the token information 63, the basic information 64, and the user information 65 are stored in the storage unit 12 of the consent portal server 10. The embodiment and the modified example, however, are not limited to this. The information 61 to 65 may be stored in a storage unit (not illustrated) installed outside the consent portal server 10. In this case, the consent portal server 10 may acquire the information 61 to 65 via the network, for example.

In each of the information processing systems 1 as the example of the embodiment and the modified example, the token information 63 held in the consent portal server 10 is synchronized with the resource IDs managed by the resource server 30. The embodiment and the modified example, however, are not limited to this. The resource IDs managed by the resource server 30 may be written to the token information 63 held in the consent portal server 10.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information provision control system comprising:
an intermediary device including
a memory; and
a processor coupled to the memory and the processor configured to:
receive, from a first terminal device, extraction information related to an acquisition request transmitted by the first terminal device to a second terminal device storing user data,
determine, based on the received extraction information, a plurality of users which are targets for the acquisition request, and
transmit first information indicating the determined plurality of users to the second terminal device.

2. The information provision control system according to claim 1, wherein
the second terminal device is configured to:
extract a plurality of pieces of user data related to the plurality of users based on the first information received from the intermediary device, and
transmit the plurality of pieces of user data to the first terminal device.

3. The information provision control system according to claim 1, wherein
the processor is further configured to:
generate the extraction information in response to receiving, from the second terminal device which has received the acquisition request, information of the acquisition request, and
transmit the extraction information to the second terminal device, and
the second terminal device is configured to transmit the extraction information to the first terminal device in response to receiving the extraction information from the intermediary device.

4. The information provision control system according to claim 1, wherein
the processor is further configured to:
receive, from the first terminal device, other extraction information related to another acquisition request transmitted by the first terminal device to the second terminal device, and
transmit second information indicating a data item requested by the first terminal device to the second terminal device when the received other extraction information indicates acquisition of meta information.

5. The information provision control system according to claim 4, wherein
the second terminal device is configured to transmit meta information corresponding to the second information to the first terminal device based on the second information received from the intermediary device.

6. The information provision control system according to claim 4, wherein the meta information includes at least one of filter information or a data format.

7. The information provision control system according to claim 4, wherein the first terminal device is configured to transmit the acquisition request to the second terminal device after receiving the meta information from the second terminal device.

8. The information provision control system according to claim 1, wherein
the first terminal device includes a first gateway configured to transmit the extraction information to the intermediary device in response to receiving the extraction information from the second terminal device, and
the second terminal device includes a second gateway configured to transmit a plurality of pieces of user data related to the plurality of users to the first terminal device in response to receiving the first information from the intermediary device.

9. A computer-implemented information provision control method comprising:
receiving, by an intermediary device from a first terminal device, extraction information related to an acquisition request transmitted by the first terminal device to a second terminal device storing user data;
determining, by the intermediary device based on the received extraction information, a plurality of users which are targets for the acquisition request; and
transmitting, by the intermediary device, first information indicating the determined plurality of users to the second terminal device.

10. The information provision control method according to claim 9, further comprising:
extracting, by the second terminal device, a plurality of pieces of user data related to the plurality of users based on the first information received from the intermediary device; and
transmitting, the second terminal device, the plurality of pieces of user data to the first terminal device.

11. The information provision control method according to claim 9, further comprising:
generating, by an intermediary device, the extraction information in response to receiving, from the second terminal device which has received the acquisition request, information of the acquisition request;
transmitting, by the intermediary device, the extraction information to the second terminal device; and
transmitting, by the second terminal device, the extraction information to the first terminal device in response to receiving the extraction information from the intermediary device.

12. The information provision control method according to claim 9, further comprising:
receiving, by an intermediary device from the first terminal device, other extraction information related to another acquisition request transmitted by the first terminal device to the second terminal device; and
transmitting, by the intermediary device, second information indicating a data item requested by the first terminal device to the second terminal device when the received other extraction information indicates acquisition of meta information.

13. The information provision control method according to claim 12, further comprising:
transmitting, by the second terminal device, meta information corresponding to the second information to the first terminal device based on the second information received from the intermediary device.

14. The information provision control method according to claim 12, wherein the meta information includes at least one of filter information or a data format.

15. The information provision control method according to claim 12, further comprising:
transmitting, by the first terminal device, the acquisition request to the second terminal device after receiving the meta information from the second terminal device.

16. The information provision control method according to claim 9, further comprising:
transmitting, by a first gateway included in the first terminal device, the extraction information to the intermediary device in response to receiving the extraction information from the second terminal device; and
transmitting, by a second gateway included in the second terminal device, a plurality of pieces of user data related to the plurality of users to the first terminal device in response to receiving the first information from the intermediary device.

17. A non-transitory computer-readable medium storing instructions executable by one or more computers, the instructions comprising:
one or more instructions for receiving, from a first terminal device, extraction information related to an acquisition request transmitted by the first terminal device to a second terminal device storing user data;
one or more instructions for determining, by the intermediary device based on the received extraction information, a plurality of users which are targets for the acquisition request; and
one or more instructions for transmitting, by the intermediary device, first information indicating the determined plurality of users to the second terminal device.
